(19) United States
(12) Patent Application Publication
(10) Pub. No.: US 2017/0228813 A1
(43) Pub. Date: Aug. 10, 2017

(54) Heuristic Method for Pre-order Line Item Release

(71) Applicant: Digital River, Inc., Minnetonka, MN (US)

(72) Inventors: Eric Zhigang Gong, Chanhassen, MN (US); Kevin Paul Swift, Plymouth, MN (US); Uma Balakrishnan, Plymouth, MN (US)

(21) Appl. No.: 15/352,737

(22) Filed: Nov. 16, 2016

Related U.S. Application Data
(60) Provisional application No. 62/255,717, filed on Nov. 16, 2015.

(51) Int. Cl. G06Q 30/06; G06Q 50/28; H04L 29/08; G06Q 30/00

(52) U.S. Cl. CPC G06Q 30/0635; G06Q 30/018; G06Q 50/28; H04L 67/26

(57) ABSTRACT

A method for determining recipients of required notices in an order processing system includes initializing a line item set of orders, each line item in the set including at least a fulfiller indicator and an indication of a bundle group, and mapping line items to a bundle group to form a bundle group map. The method further includes storing the bundle group map for pre-orders which will ship at a later promise date. The promise date is also stored. If there is a future promise date the bundled group may be a pre-ordered bundle of line items. The line items are the products ordered. The method also includes associating rules with the bundle group, including at least one rule related to required notices. If at least one of the line items associated with a bundle group is not fulfilled by the promise date, compare the current date to the promise date, and apply the rules to the at least one line item in the bundle group. In some embodiments the notice will list the other line items not yet sent to the customer.

### CLAIM OF PRIORITY

This non-provisional patent application claims priority to U.S. Provisional Patent Application No. 62/255,717 titled “Heuristic Methods for Pre-order Line Item Release” filed 16 Nov. 2015, assigned to the assignee hereof and hereby expressly incorporated by reference herein.

### BACKGROUND

To generate maximum marketing momentum and maximize product sales, many merchants, especially those online retailing merchants in software, electronics and computer games, allow customers to order products before the product available date. Pre-order sales are subject to the Federal Trade Commission's “mail order” (orders made through the mail, via the interne or by phone) mandate, which requires that the seller must have a reasonable basis to expect that the product will ship within the advertised time frame or, if no time frame is specified, within 30 days. The rule also requires that, when a seller cannot ship within the promised time, the seller must obtain the buyer's consent to a delay in shipping or refund payment for the unshipped merchandise. Sellers must obtain consent each time a delay occurs. For a first delay after the promised date, or 30 days after the order, the seller must email the customer of the right to cancel and explain how to cancel. No response from the customer at this point indicates consent to keep the order open. Alternatively, the seller may cancel the order and notify the customer that the order has been cancelled. If the item is delayed a second time, an email must be sent informing the customer they must call customer service in order to keep the order open; no response indicates a desire to cancel the order. Again, the alternative for the seller is to cancel the order and notify the customer that it has been cancelled. Failure to provide accurate notification can result in fines that could cost a seller millions of dollars each year.

Pre-order items are often sold in a bundle with one or more line items. Thus the bundled items may need to be held together and released together, driven by the pre-order line item, while other regular line items may be shipped without delay if the merchant allows partial shipping. To make this more complicated, a pre-order line item may be held by another pre-order line item. Further, the pre-order line item changes release date from time to time thus changing which pre-ordered item is the ultimate holding factor. Finally, if a pre-order line item is cancelled, it could have an impact on the release date and the release group membership and structure. The problem is to find the line items that are released together due to the presence and change of pre-order line items and to notify the customer in compliance with federal regulations. The invention described herein offers a solution to this and other problems and achieves other advantages over the prior art.

### SUMMARY

Embodiments of the present invention address the above needs and/or achieve other advantages by providing an apparatus (e.g. a system, computer program product, etc.) and methods for providing an optimal line item release and notification process for releasing pre-orders and maintaining compliance with federal regulations.

In one embodiment, a method is described determining recipients of required notices in an order processing system which includes initializing a line item set of orders, each line item in the set including at least a fulfiller indicator and an indication of a bundle group, and mapping line items to a bundle group to form a bundle group map. The method further includes storing the bundle group map for pre-orders which will ship at a later promise date. The method also includes associating rules with the bundle group, including at least one rule related to required notices. Generally notices are required a set number of days past the promise date.

In some embodiments, a first release group having a first date is associated with a second release group with a second date later than the first date. In reviewing the applicable rules, the second release date may be the controlling date for determining if notices need to be sent. Any notices will be sent based on the rules as they apply to the second later release date. In one embodiment, the method includes determining the map of line items to a bundle from the remaining converted bundle groups.

In some embodiments, a system for determining recipients of required notices includes an apparatus for initializing a line item set of orders, each line item in the set including at least a fulfiller indicator and an indication of a bundle group, and an apparatus for mapping line items to a bundle group to form a bundle group map. The system also includes storage for storing the bundle group map for pre-orders which will ship at a later promise date, and storing the later promise date. Such an apparatus may associate rules with the bundle group, including at least one rule related to required notices. A comparator compares the current date to the promise date if at least one of the line items associated with a bundle group is not fulfilled by the promise date, the system includes an apparatus for applying the rules to the at least one line item in the bundle group. The system also includes an apparatus for checking the other line items in the bundle group map for a pre-order, and an apparatus for applying rules to the other line items in the bundle group for a pre-order. In another embodiment, the system includes an apparatus for checking the other line items in the bundle group for a pre-order which checks the line items from the stored bundle group map for pre-orders. The system also includes an apparatus for applying the rules which further includes an apparatus for sending a notification that the customer regarding at least one line item not fulfilled from a pre-order. The notification lists other line items not fulfilled from a pre-order bundle in the notification to the customer.

### BRIEF DESCRIPTION OF THE DRAWINGS

FIG. 1 illustrates a high level commerce environment in accordance with one embodiment of the present invention.

FIG. 2 illustrates commerce system components in accordance with one embodiment of the present invention.

FIG. 3 provides a high level is a block diagram illustrating an exemplary set partition flow for calculating a release group and its release attributes.

FIG. 4 provides an example of release group processing.

FIG. 5 illustrates the release group life cycle in pre-order fulfillment planning: form, change and fulfill.

FIG. 6 provides an exemplary process for checking release groups for notification requirements and data.

FIG. 7 provides an exemplary schema for maintaining compliance with FTC notification requirements.

### DETAILED DESCRIPTION

The presently disclosed embodiments will now be described more fully hereinafter with reference to the accompanying drawings, in which some, but not all, embodiments of the inventive concept are shown. The invention may be embodied in many different forms and should not be construed as limited to the embodiments set forth herein; rather, these embodiments are provided so that this disclosure will satisfy applicable legal requirements.

While the invention described herein may be described in terms of a merchant web site and a commerce system providing sales over the interne, the invention may be used with other means to sell products on a pre-order basis, including telephone or catalog sales (at a physical store or by other means) or other means where the orders are processed by an order management system. Any particular order may contain line items that may be fulfilled by one or more fulfillment centers, so an order management system communicates via a network with a plurality of fulfillment centers.

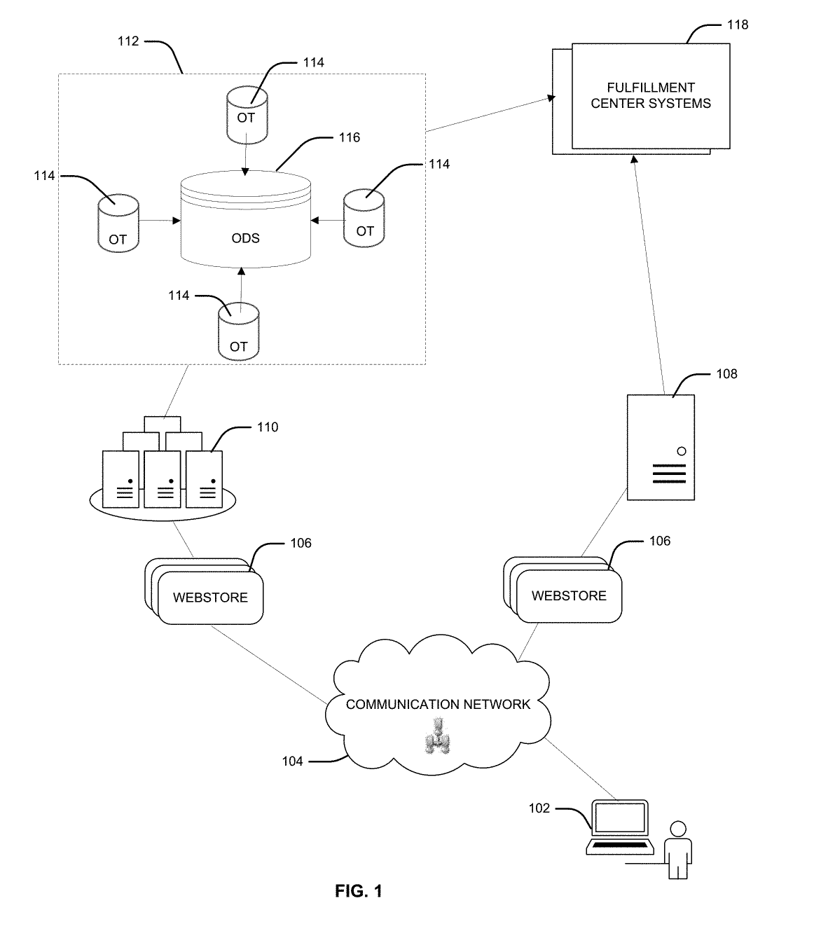

An exemplary commerce system order environment is illustrated, in a very simplified form, in FIG. 1. A user 102 with a computing device (e.g. a personal computer, laptop, tablet, smartphone or other device with networking capability) may connect to a network 104 to access a merchant or distributor website 106. A merchant or distributor 106 may host its own commerce system (as is illustrated in 108) or it may contract for commerce services with a commerce provider (as is illustrated in 110). Whether hosting its own or contracting with a service provider, the merchant's system may comprise supply chain management modules supporting order management and/or fulfillment, and may include a group of order taker modules 114 collecting order details from customers' interaction on a merchant web site 106 before writing them to an operational data store (ODS) 116. The ODS 116 may include functions and features in the form of modules for processing orders, the modules containing computer executable instructions, which when executed by a processor, provide services including validation, verification, and processing of orders. Such a system may include modules for collecting and managing orders 112 and releasing the order line items to fulfillment 118 centers where the product is prepared for shipment to the customer. An order management system and module 112 supports the ordering process and may additionally include catalog services for storing product information, pricing, offers and merchandising, communicating with customers in compliance with laws and policies and other order-related functions. Alternatively, these services may be part of additional commerce system modules which may be programmed with instructions which, when executed by the computing device processor, interact to fulfill the same purpose.

Item properties may be stored in a product catalog, bill of materials, or similar product-related module integrated with, and supporting, an order management system 112. The product module may define item properties, including fields indicating whether the item is a pre-order item and the date the product is expected in inventory, and whether and what kind of hold might be applied to the item. Fulfillment modules 118 may include executable code for performing services supporting the management of one or more fulfillment centers, including inventory management, product receiving, and pick, pack and ship functions, among others. One of ordinary skill in the art will recognize that the functionality described here as being assigned to a module may be incorporated into one, or distributed among many, modules.

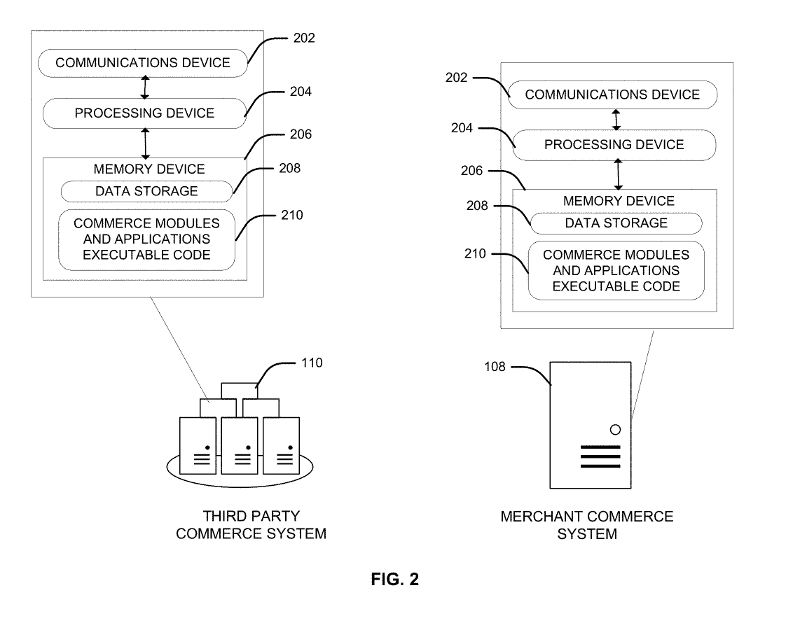

Each of the computing devices illustrated in FIG. 1 (e.g. the user device 102, third party servers 110 and merchant server 108) comprises at least a communications device component 202, a processing device component 204 and a memory device component 206, as are shown in FIG. 2. The memory device component 206 provides both volatile and non-volatile memory, the non-volatile memory providing storage locations for data 208 and executable instructions 210 for performing the features of the invention described herein, its associated programs, and other programs. In particular, computing devices such as 110, 108 are programmed (i.e. contain modules comprised of executable instructions, stored in memory) to execute the optimal line item release algorithm described below. Each computing device has a processing device component 204 which generally includes circuitry and logic that executes instructions to process data and executes the instructions stored in non-volatile, or non-transitory, memory. The processing device is operatively coupled to the communications device component 202 which allows it to access a network, such as the internet, to interface with other computing devices. Communications can occur between modules within a computing device or between devices using application programming interfaces (APIs). The communication device component 202 generally comprises a modem, server, or other device for communicating with other devices on the network. The communications device components 202 provide the means for transmitting item release information to fulfillment centers 118 and mail systems which notify the customer 102 of delays in product shipment or the need to make a decision regarding the order. The system illustrated in FIG. 1 provides one embodiment of a system that may be configured to receive customer orders that include at least one pre-order item.

An embodiment of the present invention may be described in the context of a pre-order product launch promotion. For example, a game device manufacturer may launch a new gaming console device, with pre-order availability as part of its marketing promotion. The promotion may include an offer for new games developed specifically for, and playable only on, the new device. The manufacturer may wish to create a tight bundle with these products to avoid shipping any games on a device order without the device, which may result in a poor customer experience. The game device and game products are configured as required for pre-order and promotional items in the commerce system.

The commerce system may include defined business rules to be used in pre-order line item processing; for example, the rules may determine whether product holds, other than pre-order holds, will be released at a particular point, depending on what other items on the order are available for shipping, or whether or not partial shipping is allowed. There may be a great deal of flexibility in business rules used for the heuristic processing described herein. While the business rules described below refer to a particular number and set of constraints, other rules and number and sets of constraints may be used as well.

Orders may include one or more line items from one or more merchants. Order line items may be independent or may be bundled in some manner. Bundling, in this sense, may be either a purchase bundle, whereby a customer may receive a discount, for example, for buying two different products. Or, it could be a fulfillment bundle, where for reasons related to customer satisfaction or warehouse efficiency, or the like, items should be shipped together. One of ordinary skill in the art will recognize that other types of bundling might be used for a variety of reasons. In one embodiment, a number of bundling scenarios are possible: tight, semi-tight, or loose, each with or without restrictions on one or more of the bundled items. In the example above, a merchant may bundle a new gaming device with a game that only runs on the new device. Tightly bundling in this case enhances customer satisfaction by not delivering an item to the customer that the customer cannot use until other line items ship. Bundled items are referred to as a bundle group. In addition to bundling issues, items may be placed on other types of hold for various reasons.

When orders are received, release groups (line items that may be released together) with the foregoing constraints on pre-order line items and partial shipping rules are determined. The goal of the claimed invention is to find the optimal set of line items that are released together due to the presence and change of pre-order line items or other constraints, such as partial shipping. The solution is modeled as a heuristic set partitioning solution.

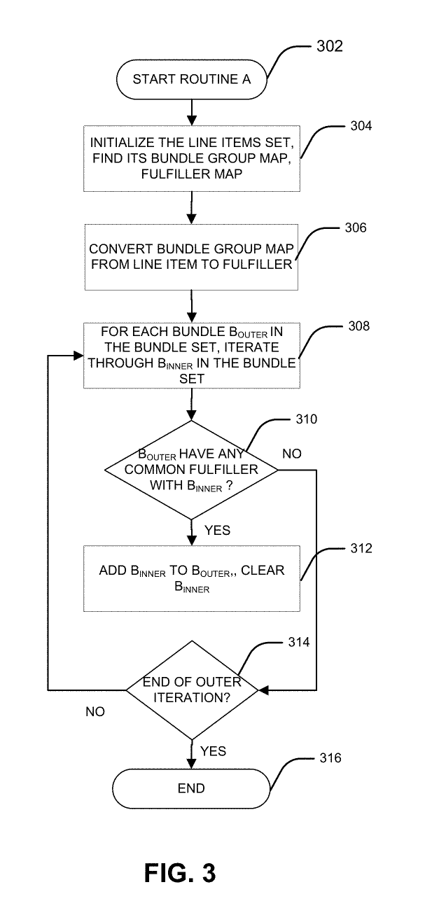

When an order with pre-order line items is received, a release group is calculated and stored in a data store. FIG. 3 illustrates the heuristic routine used to calculate the optimal fulfillment request, or release groups. As was described above, various events trigger the calculation of a new set of release groups for fulfillment 302. First, the item set is initialized and its bundle group and fulfiller maps identified 304. The bundle group map is converted from line item to fulfiller 306. Using an iterative process through B_{INNER} in the bundle set, each bundle, B_{OUTER} in the bundle set, 308. For B_{OUTER} lines identified as having a common fulfiller with B_{INNER} 310, B_{INNER} is added to B_{OUTER} and B_{INNER} is cleared 312. When B_{OUTER} and B_{INNER} have no fulfiller in common 310, 314, the iteration ends 316.

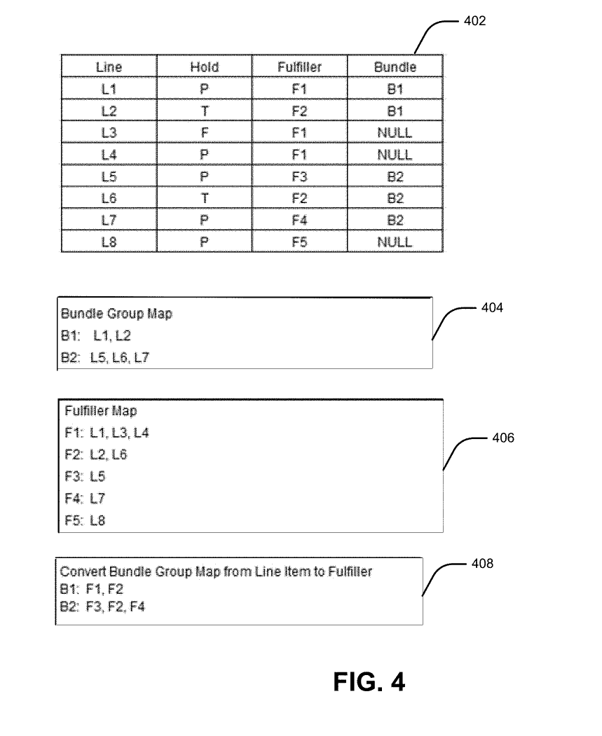

FIG. 4 provides an illustration of the heuristic method. Item 402 shows each order line item along with its hold status, fulfiller and bundle group. Item 404 illustrates a bundle group map. In this example, there are two bundle groups, one on lines L1 and L2, and the other on lines L5, L6 and L7. Item 406 illustrates a fulfiller map, with lines L1, L3 and L4 mapped to F1; L2 and L6 to F2; L5 to F3; L7 to F4; and L8 to F5. Item 408 illustrates converting the bundle group map from line item to fulfiller. Here, bundle group 1 should be fulfilled by fulfillers F1 and F2, and bundle group 2 should be fulfilled by fulfillers F3, F2 and F4.

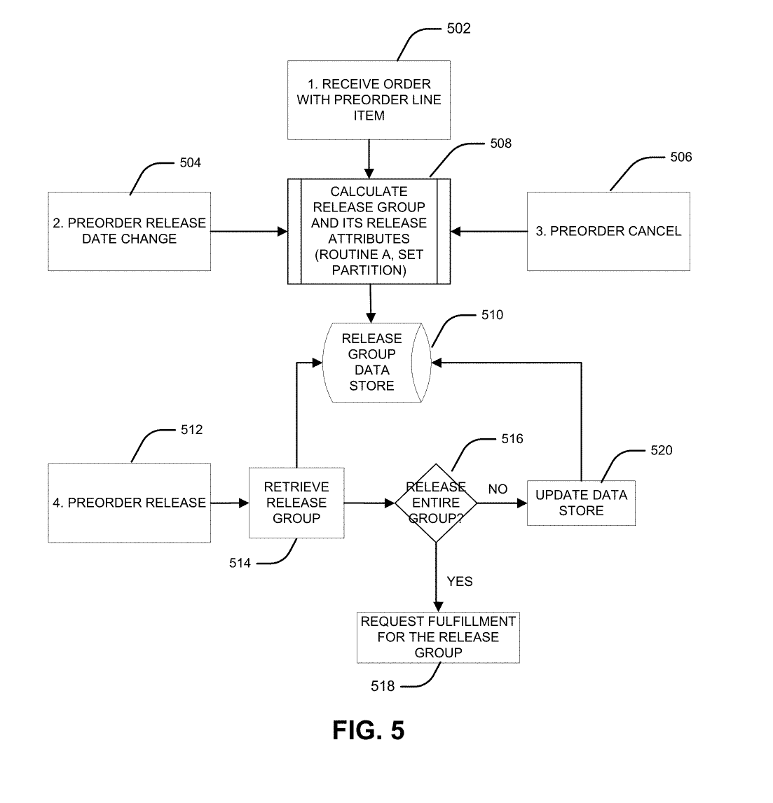

FIG. 5 illustrates release group life cycle scenarios in pre-order fulfillment planning. Events, such as order placement and receipt 502, pre-order release date change 504, and pre-order cancel 506 define scenarios that trigger the calculation of a new set of release groups for order line items 508 (and FIG. 3). Under these scenarios, release groups are optimized when only one release group per fulfiller per order is created, essentially ensuring that all items are shipped together to the extent that they can be. An order may not be released without a pre-order release date, which is determined before release or upon release. Events triggering calculation of release groups result in an optimal fulfillment request under the existing constraints, which is stored in a release group data store 510. When information has been received that requires an update of the pre-order release group 512, the release group fulfillment request is retrieved 514 from the data store and evaluated to determine whether the entire release group may be released 516. If all items are set to release, the fulfillment request may be released to the fulfillment center 518 where the items are picked, packed and shipped to the customer. If not, the data store may be updated 520 so that the order may be released when all items in the group are eligible for release.

As was described above, an optimal fulfillment request is one that delivers all items to the fulfillment center(s) at the same time, with a goal of having the items arrive at the customer location as soon as the items are available, and at the same time, and handles the changes caused by pre-order cancel and pre-order release date change.

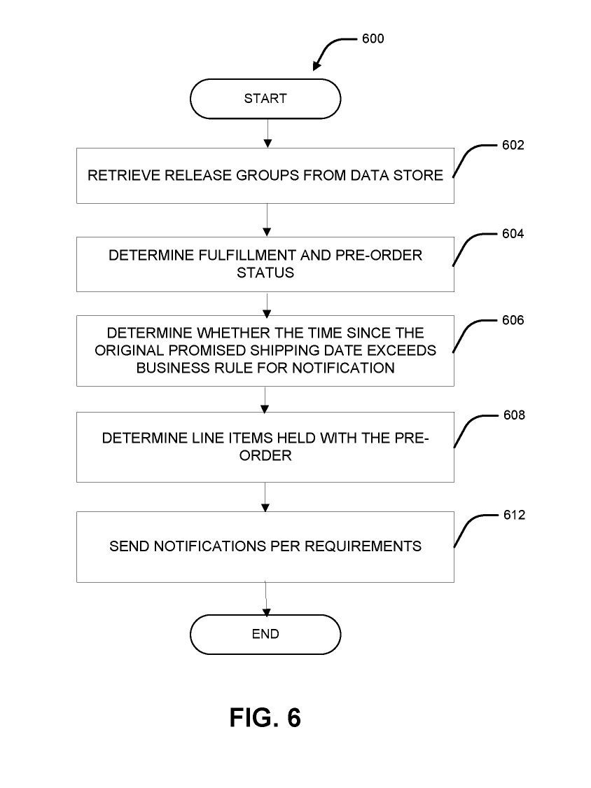

Release groups are determined initially at the time the order is placed and stored in the release group data store. Release groups are the optimal solution to the problem of notifying customers as to changes in order fulfillment because it allows the system to recalculate and change the date when it must be updated, and business rules may be applied here to determine when a notification must be sent to the customer. FIG. 6 illustrates an exemplary process used for determining if a pre-order notification is required. The process for applying business rules 600 looks at stored release groups 602 to determine whether or not it is unfulfilled (whether it has received a shipment confirmation from the fulfiller), then checks the dates for unfulfilled lines, original promise date and for preorder status 604. If it is unfulfilled when it should have been fulfilled (the current date exceeds the promised date by a pre-determined value) 606, line items being held with the pre-order line are determined 608 and a notification is sent 610. The benefit of the initial release group determination and storage is that it allows recalculation of those release groups at a later time when some data could have changed that potentially effects how the release group is calculated, or not all of the data was available at the time the order was placed. The initial release group calculation provides the original estimated delivery date which allows the system to determine when the customer must be notified. In addition, the release group allows the system to notify the customer what if any additional items are being held by the pre-order line item.

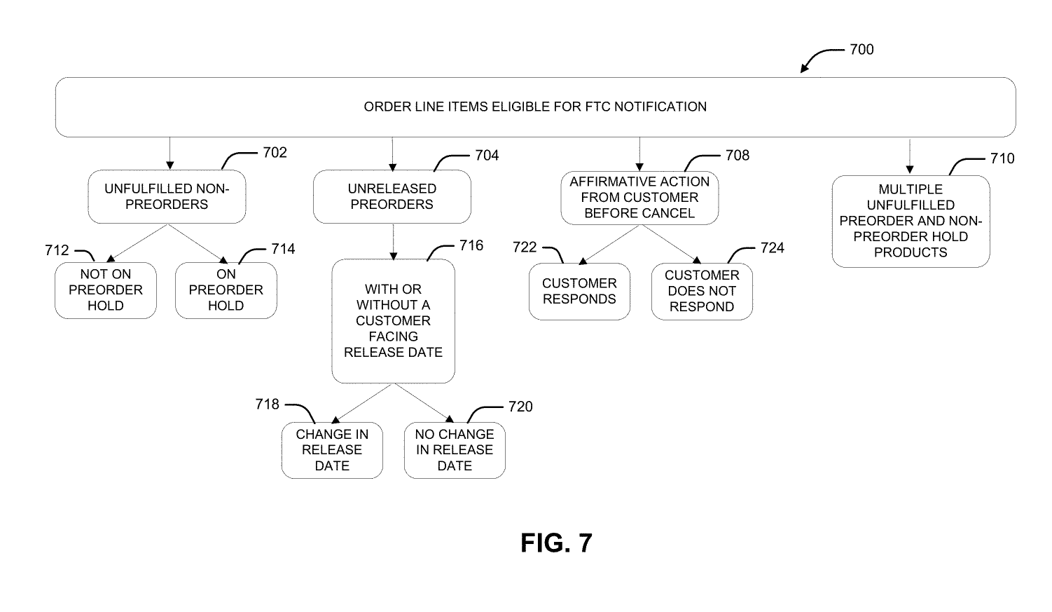

Once the system has calculated the release groups, the system may determine which orders are eligible for FTC notification. An exemplary embodiment is shown in FIG. 7. While an embodiment using FTC rules is illustrated here, the business rules may be flexible as determined by need. Order lines that are eligible for FTC notification include unfulfilled non-pre-orders 702, unreleased pre-orders 704, orders on which affirmative action is taken by the customer at the system's request 708 and multiple pre-order and non-pre-order hold products that are unfulfilled 710. Unfulfilled non-pre-orders that are not on pre-order hold 712 are sent a notification when the items are still unfulfilled at 30 days post order date. If the order is still unfulfilled at 55 days post order date, an email is sent giving the customer an opportunity to cancel the order. If the non-pre-order item is on pre-order hold 714, because it is part of a bundle or partial shipment has been disabled, the line items are treated the same as the associated pre-orders. When there is a change in release dates, the same business rules apply.

Pre-orders that are not yet released 704, with or without a customer-facing release date 716 may have different notification rules depending on whether there is a change in release date 718 or not 720. For every time the release date is changed 718, within 30 days of the release date used for order placement, the FTC notification will be resent on that date. Any miss within 30 days will result in the FTC notification being sent. When a release date is changed beyond 30 days of the original date, orders placed prior to the original date will require customer affirmative action. Any additional changes will also require affirmative action. Notification requirements are not triggered by a release date moving to one sooner than the original release date offered. If there is no change in the release date 720, the FTC affirmative action notification is sent 4 days after the system release date. If affirmative action from the customer is required before cancellation 708, an email is sent to the customer asking for affirmative action within 5 days. If the shopper doesn't respond 724, the system sends a cancellation after 5 days and the order is cancelled in the commerce system. If the customer provides a response 722, the response is recorded in the system with date. Affirmation is valid up until the date that the affirmation provided for. If a particular data is missed, and no new date is given, the affirmative action notice will be sent 4 days after the last given date. If the customer responds affirmatively, the notice will resend every 25 days based on the date the last one was sent, for 1 year. A request for cancellation may be sent after 1 year. Finally, in this example, unfulfilled line items with multiple pre-orders and non-pre-order hold products unfulfilled may be treated in a manner identical to unreleased pre-orders and unfulfilled non-pre-orders.

The foregoing describes a method for determining recipients of required notices in an order processing system which includes initializing a line item set of orders, each line item in the set including at least a fulfiller indicator and an indication of a bundle group, and mapping line items to a bundle group to form a bundle group map. The method further includes storing the bundle group map for pre-orders which will ship at a later promise date. The promise date is also stored. If there is a future promise date the bundled group may be a pre-ordered bundle of line items. The line items are the products ordered. In some instances, there may be rules to determine if the order is an actual pre-order. For example, if the promise date is one week away it may merely be a regular order that will be fulfilled when forwarded to the fulfillment facility. The method also includes associating rules with the bundle group, including at least one rule related to required notices. If at least one of the line items associated with a bundle group is not fulfilled by the promise date, compare the current date to the promise date, and apply the rules to the at least one line item in the bundle group. Generally notices are required a set number of days past the promise date. Of course rules can change and the requirements can change as well, therefore the configuration of these rules and requirements should be flexible. The method can also include checking the other line items in the bundle group map for a pre-order, and applying rules to the other line items in the bundle group for a pre-order. Checking the other line items in the bundle group for a pre-order includes checking the line items from the stored bundle group map for pre-orders. A notification is sent to the customer regarding at least one line item not fulfilled from a pre-order. In some example embodiments, the notification lists other line items not fulfilled from a pre-order bundle in the notification to the customer. This generally is more pleasing to the customer since separate e-mails or other notices are not sent to the same e-mail box. Of course, some notices may be dictated to be by regular mail and separate notices for each line item would be more costly than a single notice with all the line items listed on the notice. A method for determining release groups from a line item set of orders includes initializing a line item set of orders, each line item in the set including at least a fulfiller indicator and a bundle group, and mapping line items to a bundle group to form a bundle group map. The method also includes mapping line items to a fulfiller to form a fulfiller group map and converting the bundle group map from line items per bundle to fulfillers per bundle. The fulfillers for each bundles in the converted bundle group map are compared to an outer bundle (B_{OUTER}). If there is a common fulfiller, the bundle is added to the bundle group having a common fulfiller to B_{OUTER}. The process is repeated or iterated until the remaining converted bundle groups have no fulfillers in common with B_{OUTER}, the remaining converted bundle groups are release groups. The method also includes associating an initial promise date with each of the release groups. Bundle groups without a promise date are merely bundle groups that can be fulfilled immediately. Bundle groups that are provided with a promise date are pre-orders. The release groups and an initial promise date with each of the release groups are stored in a data store for future use. Placing the pre-order bundles and their initial promise dates initially provides for a large gain in efficiency of a computer system in the event one or more of the line items is unable to ship by the promised date. Such a pre-order is unfulfilled or at least partially unfulfilled and may trigger required notifications under the law or by governmental agencies. The method also includes applying business rules to the release group to determine if a notification must be sent to a customer. Other business rules may also be applied that relate to fulfillment of orders. For example, an order may not be fulfilled if one item is missing and the rule is that there will be no split orders at a particular fulfillment facility. The method also includes reviewing the initial promise date to determine if a notification must be sent to a customer. The method can also include determining if the line item was bundled with other line items, and determining if the other line items have been sent to the customer. If one or more of the other line items have not been sent, determining if the notification should include the other line items in the notification. In some embodiments, notifications can be sent for each line item. This, however, may overrun a customer's inbox and result in a negative consumer experience.

In some instances, a first release group having a first date is associated with a second release group with a second date later than the first date. In reviewing the applicable rules, the second release date may be the controlling date for determining if notices need to be sent. Any notices will be sent based on the rules as they apply to the second later release date. In one embodiment, the method includes determining the map of line items to a bundle from the remaining converted bundle groups.

A system for determining recipients of required notices includes an apparatus for initializing a line item set of orders, each line item in the set including at least a fulfiller indicator and an indication of a bundle group, and an apparatus for mapping line items to a bundle group to form a bundle group map. The system also includes storage for storing the bundle group map for pre-orders which will ship at a later promise date, and storing the later promise date. An apparatus for associating rules with the bundle group, including at least one rule related to required notices. A comparator compares the current date to the promise date if at least one of the line items associated with a bundle group is not fulfilled by the promise date, the system includes an apparatus for applying the rules to the at least one line item in the bundle group. The system also includes an apparatus for checking the other line items in the bundle group map for a pre-order, and an apparatus for applying rules to the other line items in the bundle group for a pre-order. In another embodiment, the system includes an apparatus for checking the other line items in the bundle group for a pre-order which checks the line items from the stored bundle group map for pre-orders. The system also includes an apparatus for applying the rules which further includes an apparatus for sending a notification that the customer regarding at least one line item not fulfilled from a pre-order. The notification lists other line items not fulfilled from a pre-order bundle in the notification to the customer.

In essence, there is much to be gained by storing the bundle map which includes the line items of each bundle along with the initial promise date for later use. The system when configured to execute the methods discussed herein becomes a specialized machine that functions differently than conventional e-commerce order and fulfillment systems. Traditional order fulfillment methods and systems are significantly slower and less efficient than a machine that has the bundled pre-orders stored in a bundle map that includes both the bundle group and the line items that make up the bundle. In order to meet federal regulations regarding pre-orders, order dates, promise dates, release dates and line items must be tracked. An initial promise date is also stored for each bundled pre-order. In some embodiments, this can be stored in the bundle map. When one of the line items is delayed and notices are required, the initial date can be quickly determined and the notice rules applied to the particular pre-order bundle group or release group. A notice can be sent to customers for the unfulfilled portion of the bundle or the entire bundle, depending on whether other line items are tightly or loosely grouped. When tightly grouped, resources can also be saved by listing the other line items associated with the pre-order on the notice. An additional advantage is that the customer gets one consolidated notice rather than one for each line item that is unfulfilled. Other rules may also be applied to the unfulfilled bundle, such as when one bundled pre-order is associated with another bundled pre-order. The rule can be checked. In some instances, the second pre-order may have another later date that controls the notifications. The notifications can be quickly generated and have a more positive effect when using the various embodiments of the invention discussed herein. The system is more flexible in that changes in rules can be applied easily to the stored pre-order bundle map. The claims below are directed to this improvement of an existing technology. The invention discussed herein also achieves other benefits over conventional order fulfillment systems and methods, including greatly reduced search times, and smaller memory requirements.

It will be appreciated by those of ordinary skill in the art that the described embodiments may be realized as a method, system, computer program product, or a combination of the foregoing. Accordingly, the disclosed embodiments may take the form of an entirely hardware embodiment, an entirely software embodiment (including resident software, microcode, etc.), or an embodiment combining software and hardware aspects that may generally be referred to herein as a “system.” The embodiments may also take the form of a computer program product on a non-transitory computer-readable medium having computer-usable program code embodied in the medium.

Any suitable non-transitory computer-usable or computer-readable storage medium may be utilized. The computer-usable or computer-readable storage medium may be, for example, but is not limited to, an electronic, magnetic, optical, electromagnetic, infrared, or semi-conductor system, apparatus, or device, but does not include a signal per se. Other examples include a portable computer diskette, a hard disk, a random access memory (RAM), a read-only memory (ROM), an erasable programmable read-only memory (EPROM) or flash memory, a portable compact disc read-only memory (CD-ROM), an optical storage device, or a magnetic storage device. In the context of this document, a non-transitory computer-usable or computer-readable storage medium may be any non-transitory medium that can contain or store a program for use by or in connection with an instruction execution system, apparatus, or device.

Computer program code for carrying out operations of the present invention may be written in any type of programming language capable of implementing its features. The program code may execute on one or more processors that may be remote from each other, or as a stand-alone software package. When multiple processors are employed, one processor may be connected to another processor through a local area network (LAN) or a wide area network (WAN), or the connection may be, for example, through the Internet using an Internet service provider (ISP).

The invention was described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer instructions may also be stored in a non-transitory computer-readable memory, as described above, that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the functions/acts specified herein described in text or as specified in a flowchart and/or block diagram block or blocks. Alternatively, computer program implemented steps or acts may be combined with operator or human implemented steps or acts in order to carry out an embodiment of the invention. As used herein, the term “coupled” includes both a direct electrical connection between blocks or components and an indirect electrical connection between blocks or components achieved using intervening blocks or components.

The individual components of the disclosed system and method are necessarily composed of a number of electronic components. Commerce platforms may be hosted on servers in a cloud environment or on a private network. Servers may be accessed by networked (e.g. internet) users through a mobile app on a remote computing device. The commerce application generally comprises application programming interfaces, a commerce engine, internal services and third party services and solutions. The application programming interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, end users may access the ecommerce system from a computer workstation or server, a desktop or laptop computer, a mobile device, or other electronic telecommunications or computing device. A commerce engine comprises a number of components required for online shopping, for example, customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wishlist, saved cart, entity, security, throttle and more). Third party services and solutions may be contracted with to provide specific services, such as address validation, payment providers, tax and financials. Merchant integrations may be comprised of merchant external systems (customer relationship management, financials, etc), sales feeds and reports and catalog and product feeds. Partner integrations may include fulfillment partners, merchant fulfillment systems, and warehouse and logistics providers. Any or all of these components may be used to support the various features of the disclosed system and method.

An electronic computing or telecommunications device, such as a laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on sub-components of the computer or device system such as a keyboard or disk drive, but may also be electronic communications between devices connected by a network, such as a wide area network (e.g. the Internet) or a local area network. The memory may include random access memory (RAM) or similar types of memory. Software applications, stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired. Where performance is impacted, additional processing power may be provisioned quickly to support computing needs. The processor may execute the software applications or programs either stored in memory or secondary storage or received from the Internet or other network.

Furthermore, it should be recognized that computational resources can be distributed, such as the order taker/ODS used by an enterprise ecommerce system, and computing devices can be merchant or commerce servers and computers. Merchant computers and devices (e.g.) are those used by end users to access information from a server over a network, such as the Internet. These devices can be a desktop PC or laptop computer, a standalone desktop, smart phone, smart TV, or any other type of computing device. Servers are understood to be those computing devices that provide services to other machines, and can be (but are not required to be) dedicated to hosting applications or content to be accessed by any number of merchant computers. Web servers, application servers and data storage servers may be hosted on the same or different machines. They may be located together or be distributed across locations. Operations may be performed from a single computing device or distributed across geographically or logically diverse locations.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. For example, the present techniques can be implemented in any kind of system that includes a hard disk drive. The embodiment was chosen and described in order to best explain the principles of the invention and the practical application and to enable others of ordinary skill in the art to understand the invention for various embodiments with various modifications as are suited to the particular use contemplated.

What is claimed is:

1. A method for determining release groups from a line item set of orders comprising:
initializing a line item set of orders, each line item in the set including at least a fulfiller indicator and a bundle group;
mapping line items to a bundle group to form a bundle group map;
mapping line items to a fulfiller to form a fulfiller group map;
convert the bundle group map from line items per bundle to fulfillers per bundle;
compare fulfillers for each bundles in the converted bundle group map to an outer bundle (Bₒᵤₜₑᵣ);
add converted bundle groups having a common fulfiller to Bₒᵤₜₑᵣ;
iterate until the remaining converted bundle groups have no fulfillers in common with Bₒᵤₜₑᵣ, the remaining converted bundle groups are release groups.

2. The method of claim 1 further comprising associating an initial promise date with each of the release groups.

3. The method of claim 1 further comprising storing the release groups and an initial promise date with each of the release groups in a data store.

4. The method of claim 1 further comprising applying business rules to the release group to determine if a notification must be sent to a customer.

5. The method of claim 4 further comprising reviewing the initial promise date to determine if a notification must be sent to a customer.

6. The method of claim 4 further comprising:
reviewing the initial promise date for a line item to determine if a notification must be sent to a customer;
determining if the line item was bundled with other line items; and
determining if the other line items have been sent to the customer, and if not, determining if the notification should include the other line items.

7. The method of claim 4 further comprising if a first release group having a first date is associated with a second release group with a second date later than the first date, wherein the second release date is the controlling date for determining if notices need to be sent.

8. The method further comprising determining the map of line items to a bundle from the remaining converted bundle groups.

9. A method for determining recipients of required notices comprising:
initializing a line item set of orders, each line item in the set including at least a fulfiller indicator and an indication of a bundle group;
mapping line items to a bundle group to form a bundle group map;
storing the bundle group map for pre-orders which will ship at a later promise date;
storing the promise date;
associate rules with the bundle group, including at least one rule related to required notices;
if at least one of the line items associated with a bundle group is not fulfilled by the promise date compare the current date to the promise date, and
apply the rules to the at least one line item in the bundle group.

10. The method of claim 9 further comprising:
checking the other line items in the bundle group map for a pre-order; and
applying rules to the other line items in the bundle group for a pre-order.

11. The method of claim 10 wherein checking the other line items in the bundle group for a pre-order includes checking the line items from the stored bundle group map for pre-orders.

12. The method of claim 10 wherein applying the rules includes sending a notification that the customer regarding at least one line item not fulfilled from a pre-order.

13. The method of claim 12 wherein the notification lists other line items not fulfilled from a pre-order bundle in the notification to the customer.

14. A system for determining recipients of required notices comprising:
means for initializing a line item set of orders, each line item in the set including at least a fulfiller indicator and an indication of a bundle group;
means for mapping line items to a bundle group to form a bundle group map;
means for storing the bundle group map for pre-orders which will ship at a later promise date;
means for storing the promise date;
means for associating rules with the bundle group, including at least one rule related to required notices;
means for comparing the current date to the promise date if at least one of the line items associated with a bundle group is not fulfilled by the promise date, and
means for applying the rules to the at least one line item in the bundle group.

15. The system of claim 14 further comprising:
means checking the other line items in the bundle group map for a pre-order; and
means for applying rules to the other line items in the bundle group for a pre-order.

16. The system of claim 14 wherein means for checking the other line items in the bundle group for a pre-order includes checks the line items from the stored bundle group map for pre-orders.

17. The system of claim 14 wherein means for applying the rules includes means for sending a notification that the customer regarding at least one line item not fulfilled from a pre-order.

18. The method of claim 17 wherein the notification lists other line items not fulfilled from a pre-order bundle in the notification to the customer.
